(19) United States
(12) Patent Application Publication
(10) Pub. No.: US 2007/0116608 A1
(43) Pub. Date: May 24, 2007

(54) Vented ceramic tip arrangement for use with a microarray

(76) Inventors: Michael Paul Birdsell, Truckee, CA (US); Mark Capalongan, Fremont, CA (US)

Correspondence Address: IPSG, P.C., P.O. BOX 700640, SAN JOSE, CA, 95170-0640, US

(21) Appl. No.: 11/286,013

(22) Filed: Nov. 23, 2005

(51) Int. Cl. B01L 3/02

(52) U.S. Cl. 422/100

(57) ABSTRACT

Vented ceramic tips are disclosed which have increased durability and precision for use in microarray technology. As such, vented ceramic tip arrangements for use with a microarray are presented including: a ceramic wall disposed about an axis, the ceramic wall defining an irregular cavity along the axis, the ceramic wall including an attachment end and a tip end; an attachment portion disposed proximal to the attachment end; the attachment portion configured to receive a matching shaft; a tip portion disposed proximal to the tip end; the tip portion configured to receive and deliver a fluidic medium; a vent portion centrally disposed along the ceramic wall; the vent portion having at least one vent, the at least one vent disposed substantially perpendicular to the first axis.

### BACKGROUND

Microarray technology developments have enabled the mapping of the human genome in a time span that was impossible only a decade ago. Indeed, the ability to process thousands of laboratory samples simultaneously has made a once tedious and time consuming task obsolete. Not surprisingly, as technology has evolved, new demands utilizing that technology have been created. Forensic DNA testing is one such example that is being widely recognized as an invaluable investigative tool for criminal investigations. These new demands have encouraged technologists to continue their search for advancements in once seemingly unrelated technologies.

One example of a seemingly unrelated technology is found in microelectronic circuit manufacturing technology. Ceramic tips used in microelectronic applications are typically used for delivering very fine interconnection wires. Interconnection wires, in some examples, may be as small as 25 microns in diameter. The ability to accurately and precisely manipulate these wires have allowed for the design of circuit features in high density, small profile packages. However, because of their unique configuration, ceramic tips used in microelectronic circuit manufacturing have found application in emerging microarray technologies.

Capillary action describes a phenomenon that occurs when a liquid is drawn into a thin tube. The capillary effect is a function of the ability of the liquid to wet a particular material. Typically, the narrower the tube, the higher the liquid will travel up the tube against others forces such as gravity, for example. Interestingly, ceramic tips used in electronic circuit manufacturing exhibits capillary effects. These effects have not gone unnoticed.

In “Ceramic Capillaries for Use in Microarray Fabrication,” Reed et al. (Reed) explores alternative uses for ceramic tips generally used in microelectronics. Reed found that ceramic tips improve the consistency of deposit morphology, resist deformation over long-term use, cost less, and offer the potential for significant improvement in deposit density. At least part of the reason the ceramic tips in Reed function is because of their inherent capillary properties. The same fine tube that delivers wires in microelectronics may also deliver fluidic media based on capillary effects.

However, ceramic tips utilized under Reed's methods may suffer from clogging in some examples. Thus, the same property that allows for capillary effects (i.e. small tube diameter) may also increase the likelihood of clogging. Further, control of volumetric parameters may be limited to tube diameter thus resulting in limited application. Still further, to prevent vapor lock, Reed utilizes hollow shafts for holding ceramic tips which may be difficult or costly to manufacture. As such, vented ceramic tip arrangements for use with a microarray are presented herein.

### SUMMARY

Vented ceramic tips are disclosed which have increased durability and precision for use in microarray technology. As such, vented ceramic tip arrangements for use with a microarray are presented including: a ceramic wall disposed about an axis, the ceramic wall defining an irregular cavity along the axis, the ceramic wall including an attachment end and a tip end; an attachment portion disposed proximal to the attachment end; the attachment portion configured to receive a matching shaft; a tip portion disposed proximal to the tip end; the tip portion configured to receive and deliver a fluidic medium; a vent portion centrally disposed along the ceramic wall; the vent portion having at least one vent, the at least one vent disposed substantially perpendicular to the first axis.

In other embodiments, microarray fluidic medium delivery systems are presented including: a number of vented ceramic tips for receiving and delivering fluidic media; a number of shafts connected with the vented ceramic tips for securing the ceramic tips; a manifold configured to receive and secure the shafts; a number of fluidic wells for presenting the fluidic media to the vented ceramic tips; and a microarray slide for receiving the fluidic media from the vented ceramic tips. In some embodiments, further embodiments include: a three-axis robotic manipulation system coupled with the manifold for moving the manifold along three axes; and a control system for controlling the robotic manipulation system. In some embodiments, vented ceramic tips include: a ceramic wall disposed about an axis, the ceramic wall defining an irregular cavity along the axis, the ceramic wall including an attachment end and a tip end; an attachment portion disposed proximal to the attachment end; the attachment portion configured to receive a matching shaft; a tip portion disposed proximal to the tip end; the tip portion configured to receive and deliver a fluidic medium; a vent portion centrally disposed along the ceramic wall; the vent portion having at least one vent, the at least one vent disposed substantially perpendicular to the first axis.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative orthogonal representation of a tip/shaft assembly in accordance with an embodiment of the present invention;

FIGS. 2A-2C are illustrative cross-sectional representations of vented ceramic tips in accordance with embodiments of the present invention;

FIGS. 3A-3B are illustrative representations of vents disposed along a plurality of planes in accordance with embodiments of the present invention; and

FIGS. 4A-4C are illustrative representations of vented ceramic tip usage in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

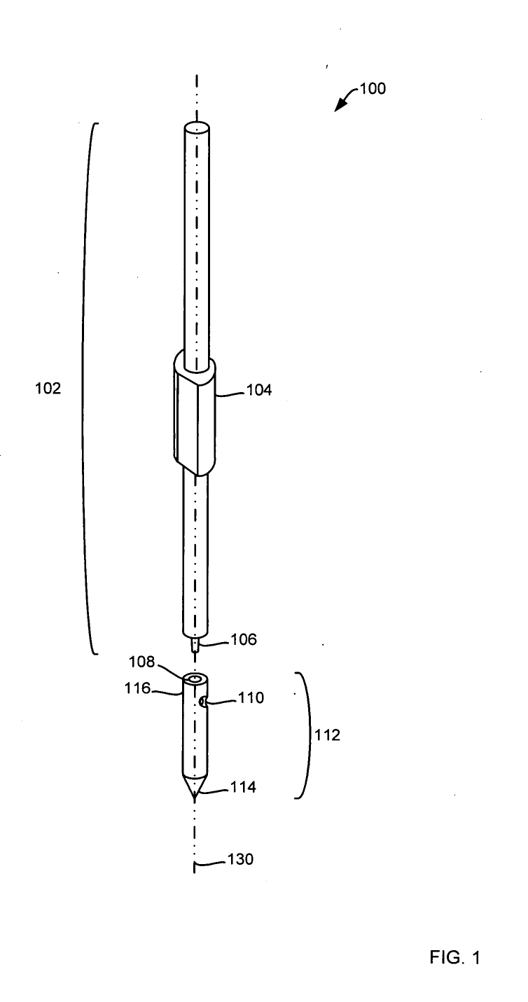

FIG. 1 is an illustrative orthogonal representation of a tip/shaft assembly 100 in accordance with an embodiment of the present invention. Assembly 100 comprises a vented ceramic tip 112 and a shaft 102. Shaft 102 may be composed of any material suitably selected to resist corrosive elements for a particular application. For example, stainless steel may be an appropriate material for shaft 102 in applications utilizing aqueous solutions. Shaft 102 may be configured with holding sleeve 104. Holding sleeve 104 serves to hold shaft 102 securely in a manifold that is configured to secure any number of shafts in accordance with user preferences. A manifold (not shown) may be coupled with a robotic manipulation system to allow movement of the manifold (and secured assemblies) through three axes. In this manner a number of fluidic wells for presenting fluidic media to an assembly may be accessed. Furthermore, a microarray slide (not shown) may be configured to receive fluidic media from an assembly secured in a manifold. In this manner, many reactions may be accomplished using micro liter volumes of fluidic media on a test site. As can be appreciated, a control system may be utilized to automate robotic manipulations in some embodiments.

Other manners of securing shaft 102 may be accomplished without departing from the present invention. Thus, shaft 102 may be configured as a straight shaft, a tapered shaft, a splined shaft, a keyed shaft, and a threaded shaft without departing from the present invention. Alignment features such as an eccentric cam (not shown) may be further utilized without departing from the present invention.

Shaft 102 may also be configured with a shaft attachment point 106. Shaft attachment point 106 is configured to receive vented ceramic tip 112. As illustrated, shaft attachment point 106 is configured with a tapered shaft, although any number of configurations may be utilized such as, a straight shaft, a splined shaft, a keyed shaft, and a threaded shaft without departing from the present invention. In some embodiments, shaft 102 may be glued, bonded, or otherwise permanently or removably affixed with vented ceramic tip 112 without departing from the present invention.

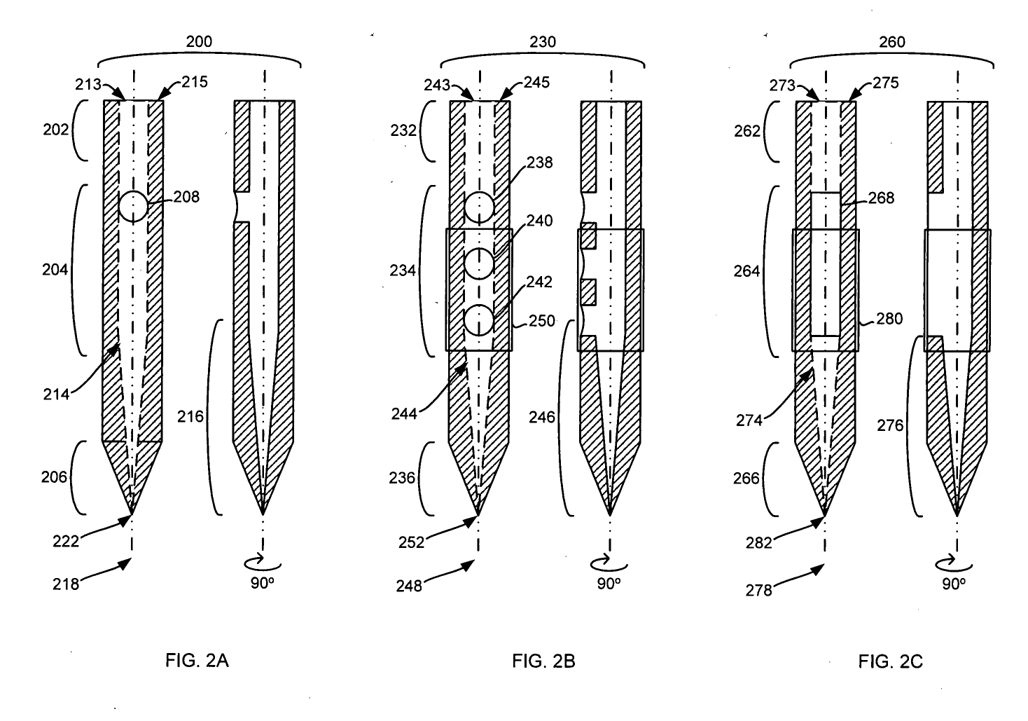

Vented ceramic tip 112 may be configured with an irregular cavity 108 disposed along axis 130. Vented ceramic tip 112 may also be configured with a vent or vent portion 110. In some embodiments more than one vent may be utilized. In other embodiments, a channel extending to irregular cavity 108 may be utilized. Vented ceramic tip 112 may also be configured with an attachment portion 116 and a tip portion 114. Vented ceramic tip 112 embodiments will be discussed in further detail below for FIGS. 2A-2C. As may be appreciated, illustrative representations are presented to clarify embodiments of the present invention. They are not necessarily to scale and no such limitation should be inferred there from.

FIGS. 2A-2C are illustrative cross-sectional representations of vented ceramic tips in accordance with embodiments of the present invention. FIG. 2A is an illustrative cross-section of a vented ceramic tip arrangement 200 configured with one vent 208. A ceramic wall 215 is disposed about axis 218 to form an irregular cavity 214. Irregular cavity 214 may be formed by molding, drilling, grinding, milling or any other method well-known in the art. In some embodiments, ceramic wall 215 may be coated with a hydrophobic compound. In other embodiments, ceramic wall 215 may be coated with a hydrophilic compound. Selection of a coating compound will depend on fluidic media characteristics.

Vented ceramic tip arrangement 200 may be configured with at least three functional areas: an attachment portion 202, a vent portion 204, and a tip portion 206. Attachment portion 202 is disposed proximal to attachment end 213 and may be configured to receive a shaft such as shaft 102 (see FIG. 1). In one embodiment, attachment portion 202 may have a diameter of approximately 760 microns. In other embodiments, attachment portion 202 may have a diameter less than or equal to 1000 microns. As noted above, attachment portion 202 may be configured to receive a straight shaft, a tapered shaft, a splined shaft, a keyed shaft, and a threaded shaft without departing from the present invention. In each of the above shaft embodiments, attachment portion 202 may be formed by molding, drilling, grinding, milling or any other method well-known in the art.

Vent portion 204 may be configured with any number of vents. In the present illustration, vent portion 204 contains one vent 208. As can be seen, vent 208 is disposed substantially perpendicular to axis 218. As may be appreciated, vent 208 may be formed by molding, drilling, grinding, milling or any other method well-known in the art without departing from the present invention.

Tip portion 206 is disposed proximal to tip end 222. In some embodiments, tip portion 206 tapers to tip end 222, tip end 222 having a diameter of approximately 28 microns. In other embodiments, tip end 222 has a diameter of approximately 20 to 60 microns. In still other embodiments, tip end 222 has a diameter less than or equal to 760 microns. In still other embodiments, tip end 222 diameter is selected to deliver a spot of fluidic medium having a diameter of approximately 40 to 70 microns. In some embodiments, tip end 222 diameter is selected to deliver a spot of fluidic medium having a diameter of approximately 30 to 200 microns. As can be appreciated, tip end 222 diameter is directly related to spot diameter. As such, any number of tip end diameters may be selected in accordance with user preferences. Finally, in some embodiments, irregular cavity 214 may be configured with a taper as seen by 90° rotated view at 216. Tapering may be utilized to enhance fluidic release from ceramic wall 215.

FIG. 2B is an illustrative cross-section of a vented ceramic tip arrangement 230 configured with three vents 238, 240, and 242. A ceramic wall 245 is disposed about axis 248 to form an irregular cavity 244. Irregular cavity 244 may be formed by molding, drilling, grinding, milling or any other method well-known in the art. In some embodiments, ceramic wall 245 may be coated with a hydrophobic compound. In other embodiments, ceramic wall 245 may be coated with a hydrophilic compound. Selection of a coating compound will depend on fluidic media characteristics.

Vented ceramic tip arrangement 230 may be configured with at least three functional areas: an attachment portion 232, a vent portion 234, and a tip portion 236. Attachment portion 232 is disposed proximal to attachment end 243 and may be configured to receive a shaft such as shaft 102 (see FIG. 1). In one embodiment, attachment portion 232 may have a diameter of approximately 760 microns. In other embodiments, attachment portion 232 may have a diameter less than or equal to 1000 microns. As noted above, attachment portion 232 may be configured to receive a straight shaft, a tapered shaft, a splined shaft, a keyed shaft, and a threaded shaft without departing from the present invention. In each of the above shaft embodiments, attachment portion 232 may be formed by molding, drilling, grinding, milling or any other method well-known in the art.

Vent portion 234 may be configured with any number of vents. In the present illustration, vent portion 234 contains three vents 238, 240, and 242. As can be seen, vents 238, 240, and 242 are disposed substantially perpendicular to axis 218. As may be appreciated, vents 238, 240, and 242 may be formed by molding, drilling, grinding, milling or any other method well-known in the art without departing from the present invention. Vented ceramic tip arrangement 230 may, in some embodiments, be configured with vent cover 250. Vent cover 250 allows vents 238, 240, and 242 to be selectively closed such that various volumetric configurations may be readily utilized. Thus, if a lower volumetric configuration is desired, vent cover 250 maybe be disposed to cover vents 238, and 240. In that configuration, fluid only rises by capillary effect to the lowest uncovered vent (e.g. vent 242). If a higher volumetric configuration is desired, vent cover 250 may be disposed to cover vents 240, and 242. In that configuration, fluid rises by capillary effect to the lowest uncovered vent (e.g. vent 238 as illustrated). In some embodiments, vent cover 250 may be permanently affixed with ceramic wall 245. In other embodiments, vent cover 250 may be removably attached with ceramic wall 245.

Tip portion 236 is disposed proximal to tip end 252. In some embodiments, tip portion 236 tapers to tip end 252, tip end 252 having a diameter of approximately 28 microns. In other embodiments, tip end 252 has a diameter of approximately 20 to 60 microns. In still other embodiments, tip end 252 has a diameter less than or equal to 760 microns. In still other embodiments, tip end 252 diameter is selected to deliver a spot of fluidic medium having a diameter of approximately 40 to 70 microns. In some embodiments, tip end 252 diameter is selected to deliver a spot of fluidic medium having a diameter of approximately 30 to 200 microns. As can be appreciated, tip end 252 diameter is directly related to spot diameter. As such, any number of tip end diameters may be selected in accordance with user preferences. Finally, in some embodiments, irregular cavity 244 may be configured with a taper as seen by 90° rotated view at 246. Tapering may be utilized to enhance fluidic release from ceramic wall 245.

FIG. 2C is an illustrative cross-section of a vented ceramic tip arrangement 260 configured with a vent channel 238. A ceramic wall 275 is disposed about axis 278 to form an irregular cavity 274. Irregular cavity 274 may be formed by molding, drilling, grinding, milling or any other method well-known in the art. In some embodiments, ceramic wall 275 may be coated with a hydrophobic compound. In other embodiments, ceramic wall 275 may be coated with a hydrophilic compound. Selection of a coating compound will depend on fluidic media characteristics.

Vented ceramic tip arrangement 260 may be configured with at least three functional areas: an attachment portion 262, a vent portion 264, and a tip portion 266. Attachment portion 262 is disposed proximal to attachment end 273 and may be configured to receive a shaft such as shaft 102 (see FIG. 1). In one embodiment, attachment portion 262 may have a diameter of approximately 760 microns. In other embodiments, attachment portion 262 may have a diameter less than or equal to 1000 microns. As noted above, attachment portion 262 may be configured to receive a straight shaft, a tapered shaft, a splined shaft, a keyed shaft, and a threaded shaft without departing from the present invention. In each of the above shaft embodiments, attachment portion 262 may be formed by molding, drilling, grinding, milling or any other method well-known in the art.

Vent portion 264 may be configured with any number of vents. In the present illustration, vent portion 264 is configured with vent channel 268. As can be seen, vent channel 268 is disposed substantially perpendicular to axis 278. As may be appreciated vent channel 268 may be formed by molding, drilling, grinding, milling or any other method well-known in the art without departing from the present invention. Vented ceramic tip arrangement 260 may, in some embodiments, be configured with vent cover 280. Vent cover 280 allows vent channel 268 to be selectively covered such that various volumetric configurations may be readily utilized. Thus, if a lower volumetric configuration is desired, vent cover 280 maybe be disposed to uncover a lower portion of vent channel 268. In that configuration, fluid only rises by capillary effect to the lowest uncovered vent channel portion. If a higher volumetric configuration is desired, vent cover 280 may be disposed to cover a lower portion of vent channel 268. In that configuration, fluid rises by capillary effect to the lowest uncovered vent channel portion. In some embodiments, vent cover 280 may be permanently affixed with ceramic wall 275. In other embodiments, vent cover 280 may be removably attached with ceramic wall 275.

Tip portion 266 is disposed proximal to tip end 282. In some embodiments, tip portion 266 tapers to tip end 282, tip end 282 having a diameter of approximately 28 microns. In other embodiments, tip end 282 has a diameter of approximately 20 to 60 microns. In still other embodiments, tip end 282 has a diameter less than or equal to 760 microns. In still other embodiments, tip end 282 diameter is selected to deliver a spot of fluidic medium having a diameter of approximately 40 to 76 microns. In some embodiments, tip end 282 diameter is selected to deliver a spot of fluidic medium having a diameter of approximately 30 to 200 microns. As can be appreciated, tip end 282 diameter is directly related to spot diameter. As such, any number of tip end diameters may be selected in accordance with user preferences. Finally, in some embodiments, irregular cavity 274 may be configured with a taper as seen by 90° rotated view at 276. Tapering may be utilized to enhance fluidic release from ceramic wall 275.

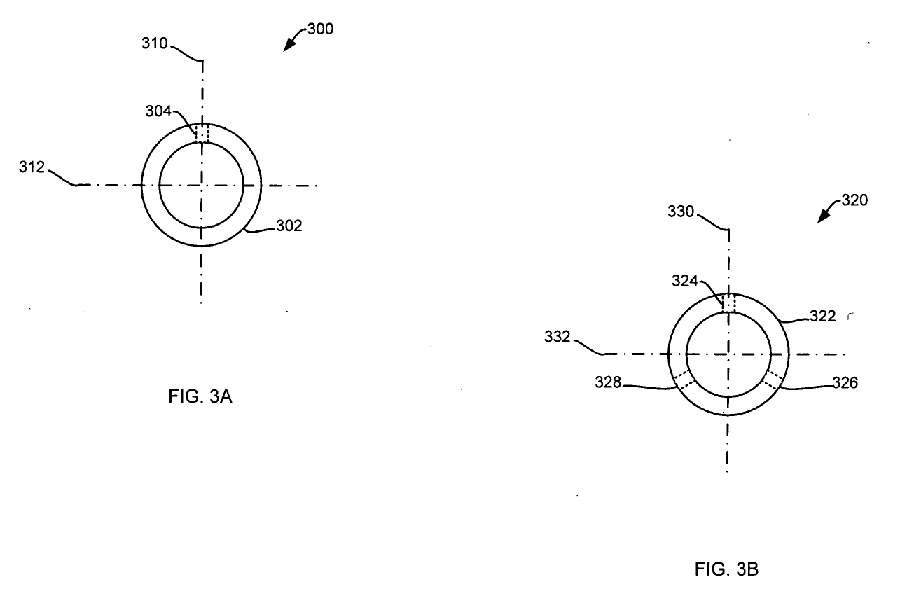

FIGS. 3A-3B are illustrative representations of vents disposed along a plurality of planes in accordance with embodiments of the present invention. FIG. 3A is an illustrative cross-sectional representation of a vented ceramic tip 300 having a single vent, multiple vents, or a channel 304 disposed along an axis 310 in accordance with embodiments of the present invention. As illustrated, ceramic wall 302 is disposed around an axis formed at the intersection of axes 310 and 312. Vent(s) or channel 304 may be disposed along axis 310. As may be appreciated, vent 304 may be formed by molding, drilling, grinding, milling or any other method well-known in the art without departing from the present invention. As may be further appreciated, vent 304, as illustrated, has a diameter and position that is intended for illustrative purposes only. Thus, no dimensional limitation should be inferred from these illustrations. Rather, these illustrations are primarily intended to illustrate positional aspects only with respect to axes described herein.

FIG. 3B is an illustrative cross-sectional representation of a vented ceramic tip 320 having a plurality of vents 324, 326, and 328 disposed along an axis 310 in accordance with embodiments of the present invention. As illustrated, ceramic wall 322 is disposed around an axis formed at the intersection of axes 330 and 332. Vents 324, 326, and 328 may be positioned equidistant from each other so as to enhance structural integrity of tip 320. In other embodiments, vents 324, 326, and 328 may be disposed more or less randomly distant from each other. As may be appreciated, vents 324, 326, and 328 may be formed by molding, drilling, grinding, milling or any other method well-known in the art without departing from the present invention. As may be further appreciated, vents 324, 326, and 328, as illustrated, have diameters and positions that are intended for illustrative purposes only. Thus, no dimensional limitations should be inferred from these illustrations. Rather, these illustrations are primarily intended to illustrate positional aspects only with respect to axes described herein.

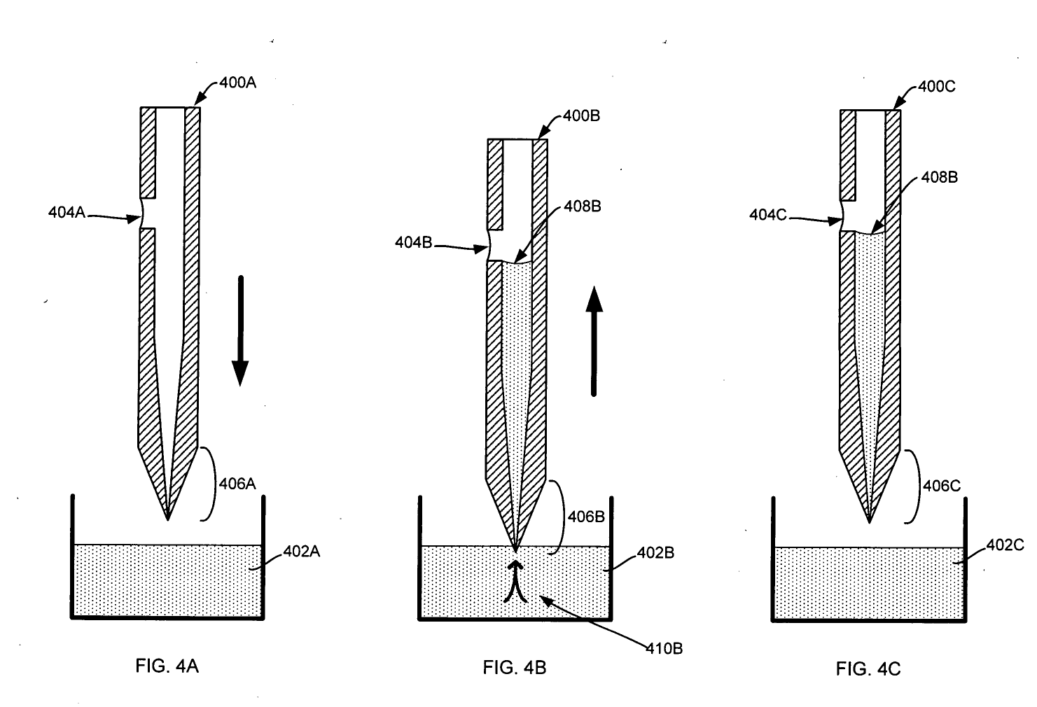

FIGS. 4A-4C are illustrative representations of vented ceramic tip usage in accordance with embodiments of the present invention. FIG. 4A is an illustrative representation of a vented ceramic tip 400A before tip portion 406A is introduced to a fluidic media 402A. In the illustrated configuration, a single vent 404A is utilized. Vented ceramic tip 400B is then lowered into fluidic media 402B as illustrated in FIG. 4B. Fluidic media 402B is drawn up and into vented ceramic tip 400B to level 408A as illustrated by arrow 410B. Fluidic media is drawn up and into vented ceramic tip 400B as a result of capillary action. Fluidic media rises to level 408A which corresponds to a lower edge of vent 404B. As illustrated, only a portion of tip portion 406B is introduced to fluidic media 402B unlike prior art systems quill systems which require full immersion into a solution to completely wet the quill.

Vented ceramic tip 400C is then raised out of fluidic media 402C. Because of surface tension, fluidic media remains in vented ceramic tip 402C and maintains level 408B. Once tip potion 406C is clear of fluidic media 402C and any container being used to store fluidic media 402C, vented ceramic tip 400C may be repositioned to a slide where a fluidic spot may be deposited. Fluid is typically deposited when fluidic media stored in a vented ceramic tip touches a slide. Surface tension acts to draw a portion of the fluidic media onto a slide. Vent 404C allows for control of volume drawn into vented ceramic tip 400C as well as discourages vapor lock that may be caused by exiting fluid.

While this invention has been described in terms of several embodiments, there are alterations, permutations, and equivalents, which fall within the scope of this invention. It should also be noted that there are many alternative ways of implementing the methods and apparatuses of the present invention. For example, although a vent cover is illustrated in FIGS. 2B-C, a vent plug may be equally utilized to cover any vents. In that vein, any manner of closing or otherwise sealing a vent may be utilized without departing from the present invention. In another example, although vented ceramic tip is illustrated as being connected with a single shaft, as in FIG. 1, a number of vented ceramic tips may also be connected with a common manifold or print head without departing from the present invention. It is therefore intended that the following appended claims be interpreted as including all such alterations, permutations, and equivalents as fall within the true spirit and scope of the present invention.

What is claimed is:

1. A vented ceramic tip arrangement for use with a microarray comprising:
a ceramic wall disposed about a first axis, the ceramic wall defining an irregular cavity along the first axis, the ceramic wall having an attachment end and a tip end;
an attachment portion disposed proximal to the attachment end; the attachment portion configured to receive a matching shaft;
a tip portion disposed proximal to the tip end; the tip portion configured to receive and deliver a fluidic medium;
a vent portion centrally disposed along the ceramic wall; the vent portion having at least one vent, the at least one vent disposed substantially perpendicular to the first axis.

2. The arrangement of claim 1 further comprising a vent cover for sealing a portion of the at least one vent.

3. The arrangement of claim 2 wherein the at least one vent is a channel disposed along the first axis

4. The arrangement of claim 1 wherein the attachment portion is configured to receive a matching shaft selected from the group consisting of: a straight shaft, a tapered shaft, a splined shaft, a keyed shaft, and a threaded shaft.

5. The arrangement of claim 4 wherein the irregular cavity at the attachment end is approximately 760 microns in diameter.

6. The arrangement of claim 1 wherein the irregular cavity along the tip portion is tapered such that the diameter of the irregular cavity at the tip end is approximately 28 microns in diameter.

7. The arrangement of claim 1 wherein the at least one vent is disposed along at least one plane, the at least one plane disposed along the first axis.

8. The arrangement of claim 1 wherein the tip portion is configured to deliver a spot of fluidic medium having a diameter of approximately 40 to 70 microns.

9. The arrangement of claim 1 wherein the ceramic wall is coated with a hydrophobic coating.

10. The arrangement of claim 1 wherein the ceramic wall is coated with a hydrophilic coating.

11. A microarray fluidic medium delivery system comprising:
a plurality of vented ceramic tips for receiving and delivering fluidic media;
a plurality of shafts connected with the plurality of vented ceramic tips for securing the plurality of ceramic tips;
a manifold configured to receive and secure the plurality of shafts;
a plurality of fluidic wells for presenting the fluidic media to the plurality vented ceramic tips; and
a microarray slide for receiving the fluidic media from the plurality of vented ceramic tips.

12. The system of claim 11 further comprising:
a three-axis robotic manipulation system coupled with the manifold for moving the manifold along three axes; and
a control system for controlling the robotic manipulation system.

13. The system of claim 11 wherein each of the plurality of vented ceramic tips comprise:
a ceramic wall disposed about a first axis, the ceramic wall defining an irregular cavity along the first axis, the ceramic wall having an attachment end and a tip end;
an attachment portion disposed proximal to the attachment end; the attachment portion configured to receive a matching shaft;
a tip portion disposed proximal to the tip end; the tip portion configured to receive and deliver a fluidic medium;
a vent portion centrally disposed along the ceramic wall; the vent portion having at least one vent, the at least one vent disposed substantially perpendicular to the first axis.

14. The system of claim 13 further comprising a vent cover for sealing a portion of the at least one vent.

15. The system of claim 14 wherein the at least one vent is a channel disposed along the first axis.

16. The system of claim 13 wherein the attachment portion is configured to receive a matching shaft selected from the group consisting of: a straight shaft, a tapered shaft, a splined shaft, a keyed shaft, and a threaded shaft.

17. The system of claim 16 wherein the irregular cavity at the attachment end is approximately 760 microns in diameter.

18. The system of claim 13 wherein the irregular cavity along the tip portion is tapered such that the diameter of the irregular cavity at the tip end is approximately 28 microns in diameter.

19. The system of claim 13 wherein the at least one vent is disposed along at least one plane, the at least one plane disposed along the first axis.

20. The system of claim 13 wherein the tip portion is configured to deliver a spot of fluidic medium having a diameter of approximately 40 to 70 microns.

21. The system of claim 13 wherein the ceramic wall is coated with a hydrophobic coating.

22. The system of claim 13 wherein the ceramic wall is coated with a hydrophilic coating.
